(19) United States
(12) Patent Application Publication
(10) Pub. No.: US 2004/0249896 A1
(43) Pub. Date: Dec. 9, 2004

(54) Communication terminal

(76) Inventors: Shintaro Watanabe, Osaka (JP); Michiaki Koizumi, Osaka (JP)

Correspondence Address: Gerald T. Bodner, Esq., BODNER & O'ROURKE, LLP, Suite 108, 425 Broadhollow Road, Melville, NY, 11747, US

(21) Appl. No.: 10/858,222

(22) Filed: Jun. 1, 2004

(30) Foreign Application Priority Data
Jun. 3, 2003 (JP) 2003-157430

(51) Int. Cl. G06F 15/16

(52) U.S. Cl. 709/206

(57) ABSTRACT

A handheld terminal has a function of saving a received electronic mail into a memory. A CPU specifies a sender of the electronic mail received this time, and detects from the memory the electronic mail received from this sender in the past. If the specified sender is registered on a list of candidates to be deleted, and a receiving date of the electronic mail detected from the memory is older than a week or more days, the CPU deletes the detected electronic mail from the memory.

### BACKGROUND OF THE INVENTION

1. Field of the Invention

The present invention relates to a communication terminal. More specifically, the present invention relates to a communication terminal having a function of receiving an electronic mail.

2. Description of the Prior Art

One example of such a kind of a conventional communication terminal is disclosed in Japanese Patent Laying-open No. 2002-169758 laid-open on Jun. 14, 2002. According to this prior art, when it is instructed to delete an electronic mail, the electronic mail having the same address as the instructed electronic mail is detected from a plurality of the electronic mails received in the past, and the detected electronic mails are deleted all at once. This makes it possible to efficiently place unnecessary electronic mails in order.

However, the prior art requires to perform a manual deleting operation, and if a user fails to perform the deleting operation, the received electronic mail is continued to be accumulated in a receiving box. Herein, if a function, which is to preferentially delete the electronic mail having the old date when the receiving box becomes occupied, is applied to the prior art, it becomes possible to prevent a mail receiving process from being destroyed. However, this leads to a problem that an important electronic mail, too, is deleted. It is noted that a function of applying a manual setting of a protection to the important electronic mail results in a deterioration in operability.

### SUMMARY OF THE INVENTION

Therefore, it is a primary object of the present invention to provide a communication terminal capable of efficiently managing an electronic mail.

According to the present invention, a communication terminal that saves a received electronic mail into a memory, and comprises: a detector for detecting from the memory the electronic mail received in the past from a specific sender who is a sender of a noticed electronic mail; a first determiner for determining whether or not a first condition is satisfied between the noticed electronic mail and the electronic mail detected by the detector; and a first deletor for deleting the electronic mail detected by the detector when a determination result of the first determiner is positive.

The detector detects from the memory the electronic mail received in the past from a specific sender who is a sender of a noticed electronic mail. Furthermore, the first determiner determines whether or not a first condition is satisfied between the noticed electronic mail and the detected electronic mail. If a determination result of the first determiner is positive, the detected electronic mail is deleted by the first deletor.

As a result of the first condition correlated with the noticed electronic mail and the specified electronic mail of the past being determined, it is possible for an operator to efficiently delete a desired electronic mail.

Preferably, it is determined by a second determiner whether or not the specific sender satisfies a second condition. The first determiner performs a determining operation when a determination result of the second determiner is positive.

Preferably, the second condition includes a registering condition that an identifying code of the specific sender is registered in a first register. Thereby, it becomes possible to manage from whom the electronic mails are to be deleted.

Preferably, when the registering condition is not satisfied, a third determiner determines whether or not the identifying code of the specific sender is registered in a second register. Herein, a first registerer registers the identifying code of the specific sender into the first register when a determination result of the third determiner is negative.

Thereby, in a case of receiving the electronic mail from the sender not registered in the first register and the second register, the sender of such the electronic mail is automatically registered in the first register. That is, it solves a trouble of registering into the first register that manages the sender intended to be deleted.

Further preferably, an acceptor accepts an input of a desired identifying code. In addition, a second registerer registers the desired identifying code into the first register. Furthermore, an ouputter outputs a message when the desired identifying code is registered in the second register. Herein, a second deletor deletes the desired identifying code from the second register corresponding to the input in response to the message. The same identifying code as the input identifying code is deleted from the second register based on an instruction of the operator.

Still further preferably, the first condition includes a first threshold value condition that a difference between a receiving date of the noticed electronic mail and a receiving data of the detected electronic mail exceeds a first threshold value.

Or, the noticed electronic mail is the latest electronic mail, the electronic mail detected by the detector is the oldest electronic mail, and the first condition includes a second threshold value condition that the number of electronic mails existing between the latest electronic mail and the oldest electronic mail out of the electronic mails from the specific sender exceeds a second threshold value.

Thereby, it is possible to automatically delete the already-received electronic mails other than a set arbitrary period, or the already-received electronic mails having any other number other than the set arbitrary number of mails.

Yet still further preferably, an unread electronic mail is excluded from candidates to be deleted by an excluder out of the electronic mails detected by the detector. Thereby, it becomes possible to prevent the unread electronic mail from being automatically deleted.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing one embodiment of the present invention;

FIG. 2(A) is an illustrative view showing one example of a display state when a mail is received;

FIG. 2(B) is an illustrative view showing one example of a display state when a receiving box is opened;

FIG. 2(C) is an illustrative view showing one example of a display state when a “friend” folder is opened;

FIG. 2(D) is an illustrative view showing one example of a display state when a received mail is opened;

FIG. 3 is a flowchart showing one portion of an operation of a FIG. 1 embodiment;

FIG. 4 is a flowchart showing one portion of another operation of the FIG. 1 embodiment;

FIG. 5(A) is an illustrative view showing one example of a display state of a function setting menu;

FIG. 5(B) is an illustrative view showing another example of the display state of the function setting menu;

FIG. 5(C) is an illustrative view showing the other example of the display state of the function setting menu;

FIG. 5(D) is an illustrative view showing a further example of the display state of the function setting menu;

FIG. 6(A) is an illustrative view showing another example of the display state of the function setting menu;

FIG. 6(B) is an illustrative view showing the other example of the display state of the function setting menu;

FIG. 7 is an illustrative view showing one example of a mail receiving history stored in a memory;

FIG. 8 is an illustrative view showing one example of an address book stored in the memory;

FIG. 9 is an illustrative view showing one example of a list of candidates to be deleted stored in the memory;

FIG. 10 is a flowchart showing another portion of the operation of the FIG. 1 embodiment;

FIG. 11 is a flowchart showing the other portion of the operation of the FIG. 1 embodiment; and

FIG. 12 is a flowchart showing another portion of the FIG. 1 embodiment.

### DETAILED DESCRIPTION OF THE PREFERRED EMBODIMENTS

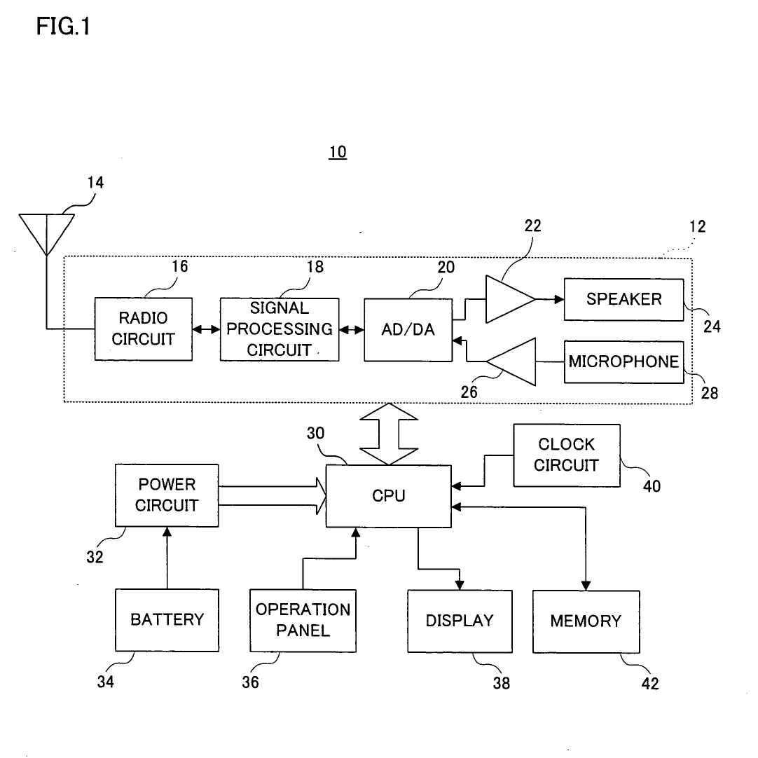

Referring to FIG. 1, a communication terminal 10 of this embodiment includes a wireless communication circuit 12 that performs a wireless communication via a wireless communication system, a CPU 30, a power circuit 32, a battery 34, an operation panel 36, a display 38, a clock circuit 40, and a non-volatile memory 42. The wireless communication circuit 12 includes an antenna 14, a radio circuit 16, a signal processing circuit 18, an AD/DA converter 20, amplifiers 22 and 26, a speaker 24, and a microphone 28. Such the communication terminal 10 is driven by a power from power circuit 32 connected to the battery 34.

The communication terminal 10 receives modulated sound data transmitted from a base station through the antenna 14. The received modulated sound data is demodulated by the radio circuit 16, and the demodulated sound data is decoded by the signal processing circuit 18. The decoded sound data is converted into a sound signal, which is an analog signal, by the AD/DA converter 20, and the converted sound signal is output from the speaker 24 via the amplifier 22. In addition, the sound signal perceived by the microphone 28 is amplified by the amplifier 26, and converted into sound data, which is a digital signal, by the AD/DA converter 20. The signal processing circuit 18 encodes the sound data output from the AD/DA converter 20, and the radio circuit 16 modulates the encoded sound data output from the signal processing circuit 18. The modulated sound data is transmitted from the antenna 14 toward the base station.

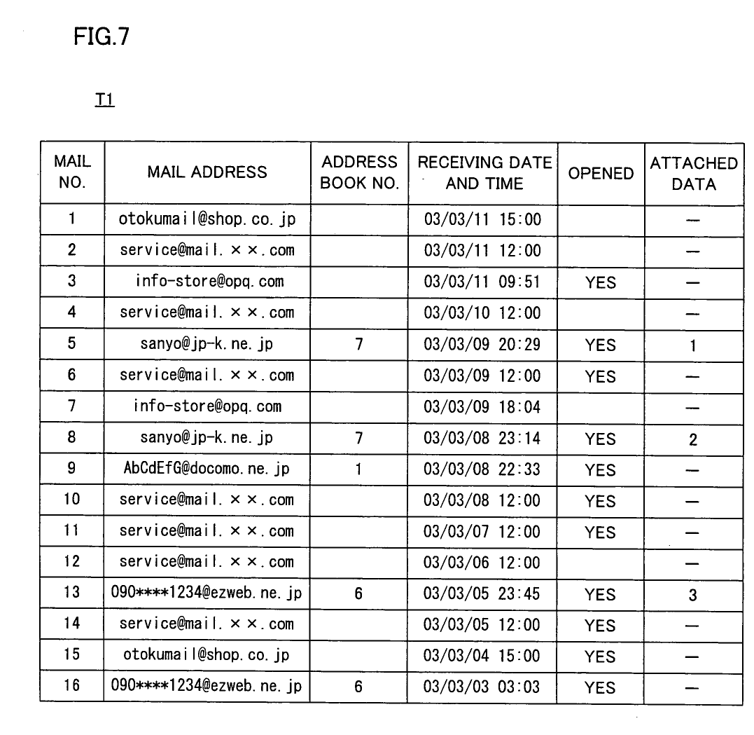

When an electronic mail (hereinafter briefly referred to as a “mail”) is created, an operator looks at the display 38, and operates the operation panel 36. If it is instructed by the operator to transmit the created mail, the CPU 30 applies data of the created mail, which is mail data, to the signal processing circuit 18. After being applied to an encoding process by the signal processing circuit 18, and a modulating process by the radio circuit 16, the mail data is delivered from the antenna 14. On the other hand, in a case of receiving the mail data via the antenna 14 from the base station, the received mail data is input into the CPU 30 via a demodulating process by the radio circuit 16, and a decoding process by the signal processing circuit 18. The CPU 30 stores the input mail data into the memory 42, and creates a mail receiving history T1 shown in FIG. 7 on the memory 42.

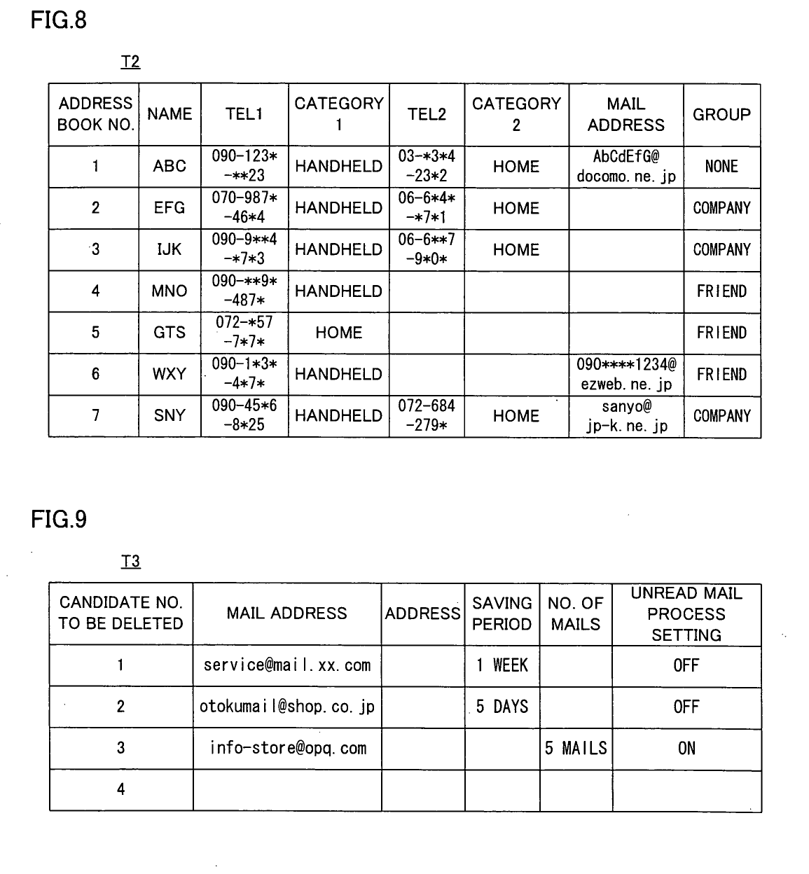

According to FIG. 7, the mail receiving history T1 has columns of a “Mail No.”, a “Mail address”, an “Address book No.”, a “Receiving date and time”, an “Opened”, and an “Attached data”. The “Mail No.” is an identifying number allotted to the mail in the order of the mails to be received. In the column of the “Mail address”, a mail address of a sender is written. In a case that the sender is registered in an address book T2 shown in FIG. 8, the identifying number allotted to this sender in the address book T2 is written into the column of the “Address book No.”. In the column of the “Receiving date and time”, a date and a time on which the mail is received are written. When the mail is opened, “Yes” is written into the column of the “Opened”. In a case that image data or music data is attached to the mail, the number indicating a category of such the attached data are written into the column of the “Attached data”.

Referring to FIG. 8, the address book T2 has columns of an “Address No.”, a “Name”, a “TEL 1”, a “Category 1”, a “TEL 2”, a “Category 2”, a “Mail address”, and a “Group”. The “Address book No.” is the number for identifying a communicating partner. In the column of the “Name”, a name of the communicating partner is written. In the columns of the “TEL 1” and the “TEL 2”, a telephone number of the communication partner is written. In the column of the “Category 1”, written is category information for identifying whether the telephone number written in the “TEL 1” is a handheld telephone receiver or a home-use telephone receiver. In the column of the “Category 2”, written is the category information for identifying whether the telephone number written in the “TEL 2” is a handheld telephone receiver or a home-use telephone receiver. In the column of the “Mail address”, a mail address of the communicating partner is written, and in the column of the “Group”, a category of groups to which the communicating partner belongs is written. Such the address book T2, too, is stored in the memory 42.

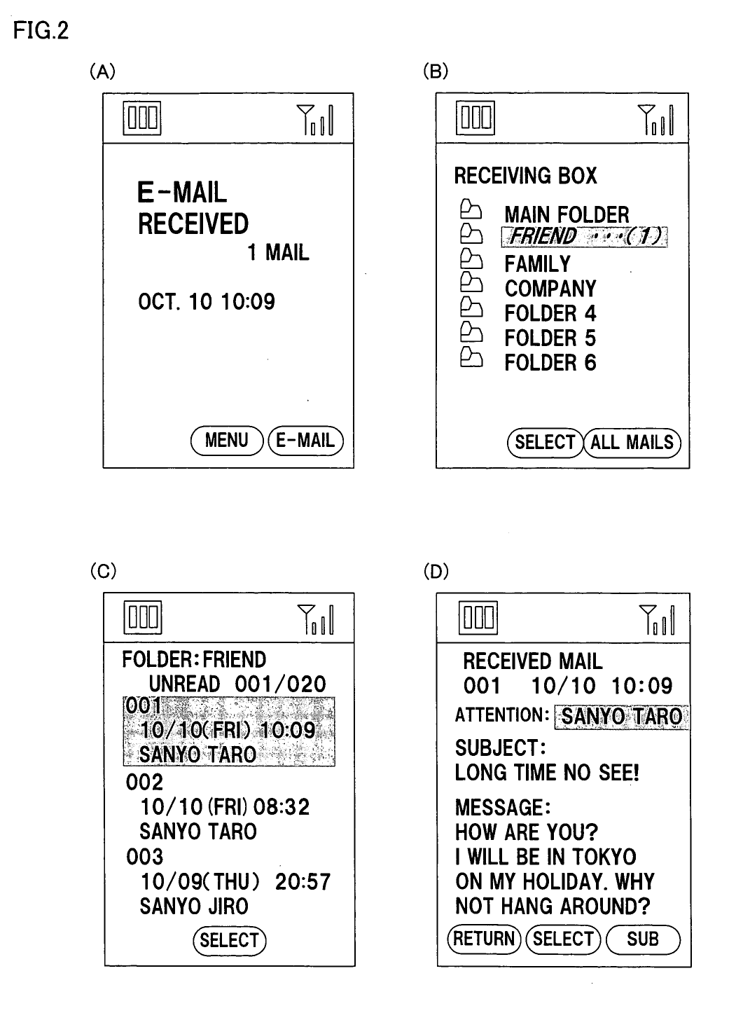

Returning to FIG. 1, the CPU 30 that received the mail data starts a ringer or a vibrator (neither is shown) for informing that the mail has been received by an audible message. Furthermore, the CPU 30 displays a receiving notice shown in FIG. 2(A) on the display 38 for informing that the mail has been received by a visible message. The operator is capable of knowing that the mail has been received by such the audible message and the visible message.

Herein, if the operator performs a mail confirming operation by the operation panel 36, a receiving box screen shown in FIG. 2(B) is displayed on the display 38. According to this receiving box screen, the operator is capable of confirming in which folder a newly received mail is stored. According to FIG. 2(B), the received mail is stored in a “friend” folder.

If the operator performs a selecting operation of the “friend” folder by the operation panel 36, a mail list shown in FIG. 2(C) is displayed. Furthermore, if the operator performs an opening operation of a desired mail, the sender, a title, a mail message of this mail is displayed as shown in FIG. 2(D).

To automatically delete the mail stored in the memory 42, it is needed to set an automatic deleting mode by the operation panel 36. The automatic deleting mode is a mode for automatically deleting a mail that satisfies a predetermined condition with the mail received this time, out of the mails received until this time.

The predetermined condition includes a sender condition that defines whose mail is to be deleted, and a threshold value condition that defines which mail is to be deleted depending on how many days old the mails are or the number of items of the mails (how far in advance the mails had been received). It is noted that details of this will be described later.

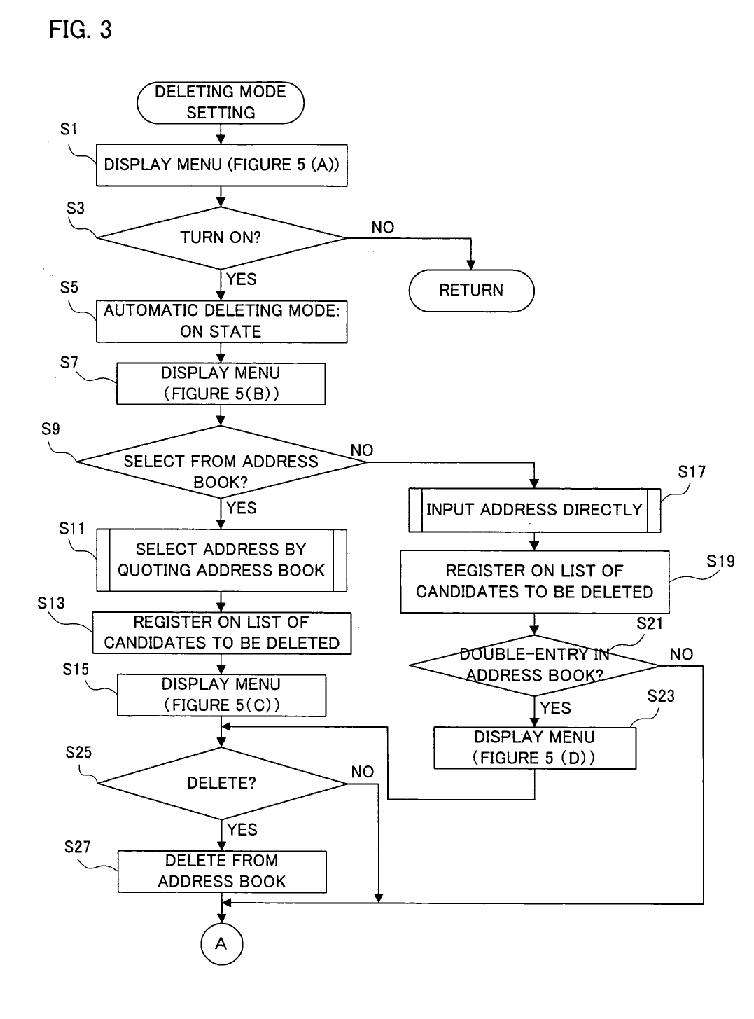

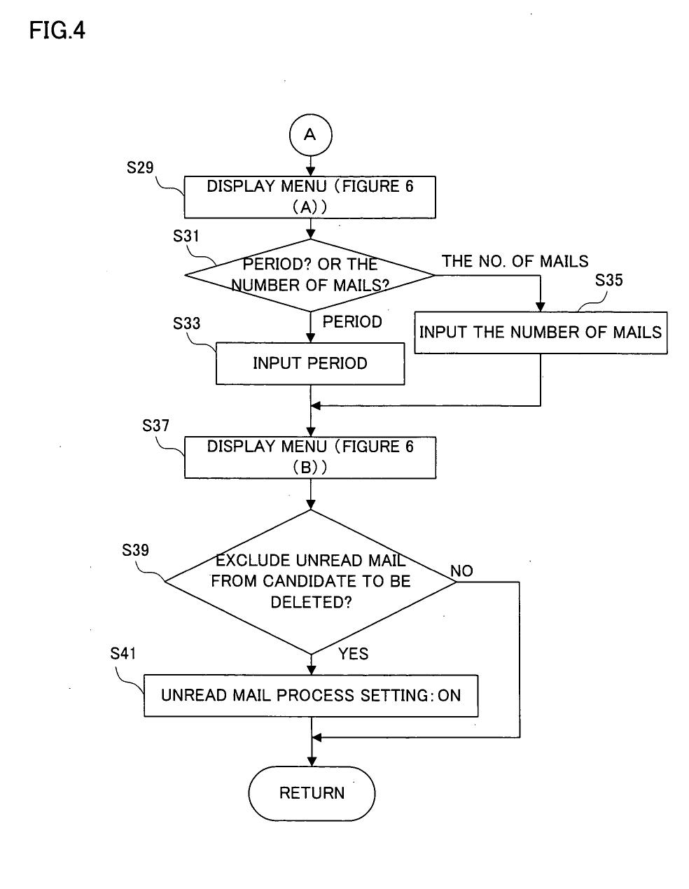

Regarding a setting of the automatic deleting mode, the CPU 30 performs a process according to flowcharts shown in FIG. 3 and FIG. 4. It is noted that a controlling program corresponding to these flowcharts is stored in the memory 42.

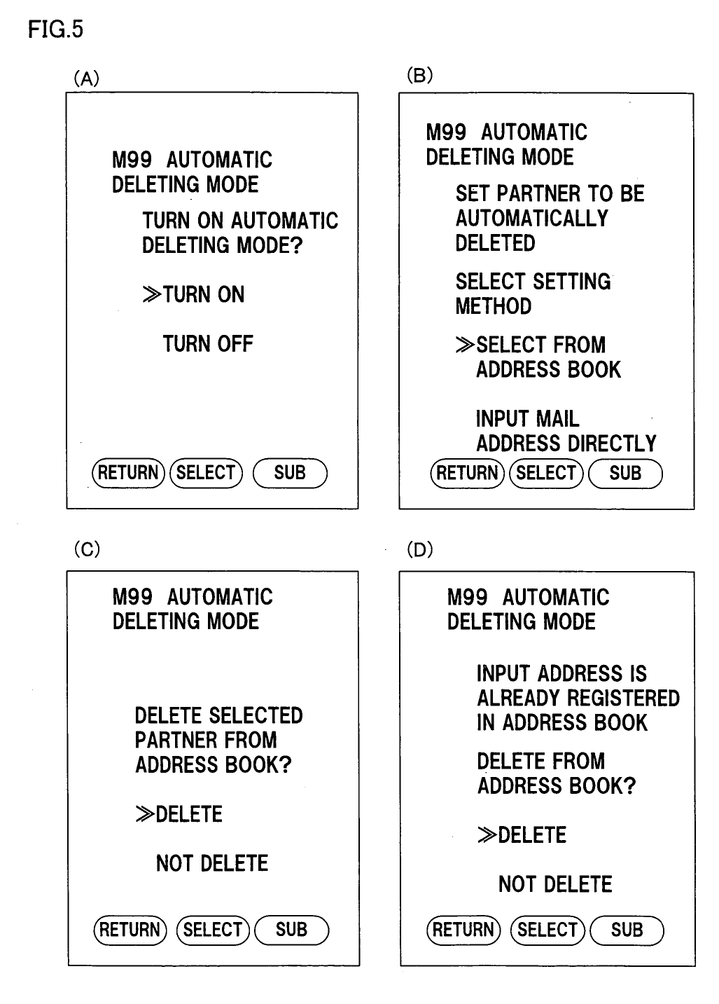

First, in a step S1, a menu screen shown in FIG. 5(A) is displayed on the display 38. According to FIG. 5(A), a message that asks “turn on automatic deleting mode?”, and menu items of “turn on” and “turn off” are displayed. The operator operates the operation panel 36 as to select the desired menu item. In a step S3, it is determined which item was selected, that is, “turn on” or “turn off”. When “turn off” is selected, the process directly returns to a routine on a higher hierarchy.

When “turn on” is selected, the automatic deleting mode is set to an on-state in a step S5, and a menu screen shown in FIG. 5(B) is displayed on the display 38 in a step S7. According to FIG. 5(B), a message of “set partner to be automatically deleted. Select setting method”, and menu items of “select from address book” and “input mail address directly” are displayed. The operator operates the operation panel 36 as to select the desired menu item.

In a step S9, it is determined which item was selected, that is, “select from address book” or “input mail address directly”. When “select from address book” is selected, the process advances to a step S11 so as to select the desired communicating partner from the address book T2 according to the operation of the operation panel 36. In a step S13, the mail address and the name of the communicating partner selected in the step S11 are registered on a list of candidates to be deleted T3 (see FIG. 3).

In a step S15, a menu screen shown in FIG. 5(C) is displayed on the display 38. According to FIG. 5(C), a message of “delete selected partner from address book?”, and menu items of “delete” and “not delete” are displayed. The operator operates the operation panel 36 as to select the desired menu item.

If NO is determined in the step S9, that is, “input mail address directly” is selected on the menu screen shown in FIG. 5(B), the process advances to a step S17 so as to accept a direct input of the mail address by the operation panel 36. In a step S19, the input mail address is registered on the list of candidates to be deleted T3, and in a succeeding step S21, it is determined whether or not the same mail address as the input mail address exists in the address book T2.

Herein, if NO is determined, the process advances to a step S29. However, if YES is determined, a menu screen shown in FIG. 5(D) is displayed on the display 38 in a step S23. According to FIG. 5(D), a message of “input address is already registered in address book. Delete from address book?”, and menu items of “delete” and “not delete” are displayed.

In a step S25, it is determined which menu item was selected, that is, “delete” or “not delete” on the menu screen shown in FIG. 5(C) or FIG. 5(D). When “delete” is selected, the process advances to a step S27 so as to delete an entry of the communicating partner that includes the selected address from the address book T2. Upon completion of deleting, the process advances to a step S29. On the other hand, when “not delete” is selected, the process directly advances to the step S29.

From the step S29 to a step S35, a setting process of a deletion determining reference is performed. Herein, the deletion determining reference is a reference for determining which mail received until this time from the communicating partner selected in the step S11 or the step S17 is to be deleted. A parameter that serves as the reference is a passage period from the date of reception or the number of receptions.

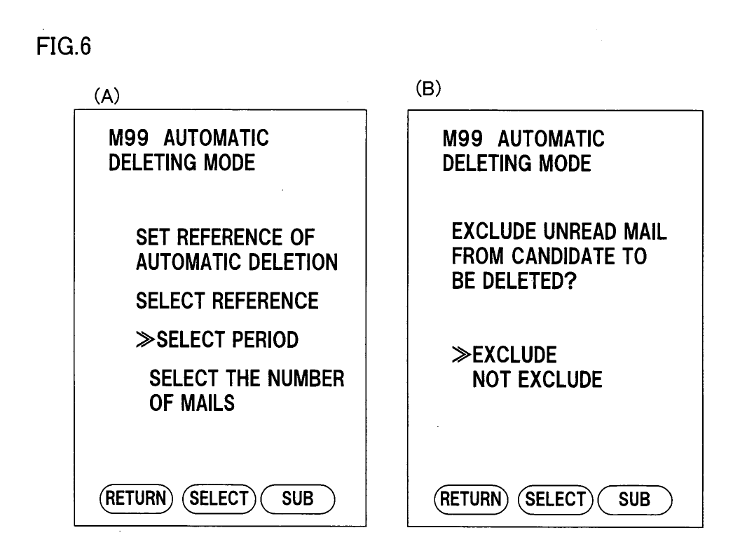

In the step S29, a menu screen shown in FIG. 6(A) is displayed on the display 38. According to FIG. 6(A), a message of “set reference of automatic deletion. Select reference”, and menu items of “select period” and “select number of receptions” are displayed. The operator operates the operation panel 36 so as to select one of “select period” and “select the number of receptions”.

In the step S31, it is determined which menu item was selected, that is, “select period” or “select the number of receptions”. If “select period” is selected, the process advances to the step S33 so as to accept an input of an arbitrary period by the operation panel 36. If “select the number of receptions” is selected, the process advances to the step S35 so as to accept the input of the arbitrary number by the operation panel 36. The input period or the number is registered on the list of candidates to be deleted T3.

In a step S37, the menu screen shown in FIG. 6(B) is displayed on the display 38. According to FIG. 6(B), a message of “exclude unread mail from candidate to be deleted?”, and menu items of “exclude” and “not exclude” are displayed. The operator operates the operation panel 36 so as to select the desired menu item. It is noted that the unread mail is a mail that the operator has not confirmed its content among the received mails.

In a step S39, it is determined which menu item, that is, “exclude” or “not exclude”, is selected. When “not exclude” is selected, the process directly returns to a routine on a higher hierarchy, and when “exclude” is selected, an unread mail process setting of “ON” is registered on the list of candidates to be deleted T3 in a step S41. Then, the process returns to a routine on a higher hierarchy.

It is noted that the unread mail process is a process in which the unread mail is excluded from the mails to be deleted by the deleting process in a step S71 described later.

The list of candidates to be deleted T3 is a list that stores the communicating partner corresponding to the mail to which the automatic deletion is applied, and stored in the memory 42. A candidates to be deleted registered on the list of candidates to be deleted T3 includes a friend having so frequent mail exchanges that it is troublesome to delete the received mail, a friend not registered in the address book T2 yet, a mail partner not necessary for the mail receiver to return the mail such as a mail delivery service.

Referring to FIG. 9, the list of candidates to be deleted T3 has columns of a “No. of candidates to be deleted”, a “Mail address”, a “Name”, a “Saving period”, a “Number of mails”, and an “Unread mail process setting”. The “No. of candidates to be deleted” is an identifying number allotted to the candidates to be deleted. In the columns of the “Mail address” and the “Name”, the mail address and the name of the candidates to be deleted are written. This writing is executed in the step S13 or the step S19. In the column of the “Saving period” or the “Number of mails”, a “Time period” and a “Number” that serve as the deletion determining reference are written. This writing is executed in the step S33 of the step S35. In the column of the “Unread mail process setting”, setting information for identifying whether or not to perform the unread mail process is written. This writing is executed in the step S41.

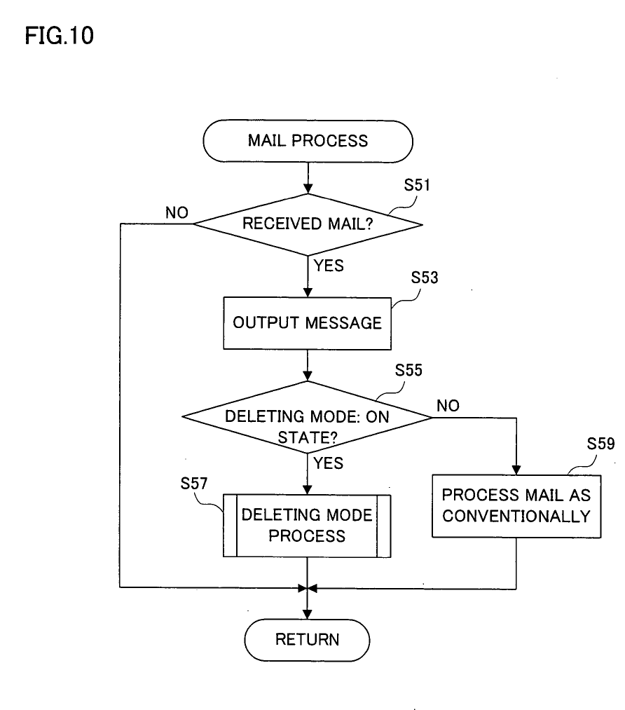

The CPU 30 executes a process according to flowcharts shown in FIG. 10-FIG. 12 in conjunction with the mail process. It is noted that the controlling program corresponding to these flowcharts, too, are stored in the memory 42.

First, referring to FIG. 10, it is determined whether or not the mail is received in a step S51, and if NO, the process returns to a routine on a higher hierarchy. If YES, the process advances to a step S53 so as to output the audible message or the visible message informing that the mail has been received. In a step S55, It is determined whether or not a deleting mode is the on-state. If YES, a deleting mode process is executed in a step S57, and if NO, a process similar to a conventional process is executed in a step S59. Upon completion of the step S57 or the step S59, the process returns to a routine on a higher hierarchy.

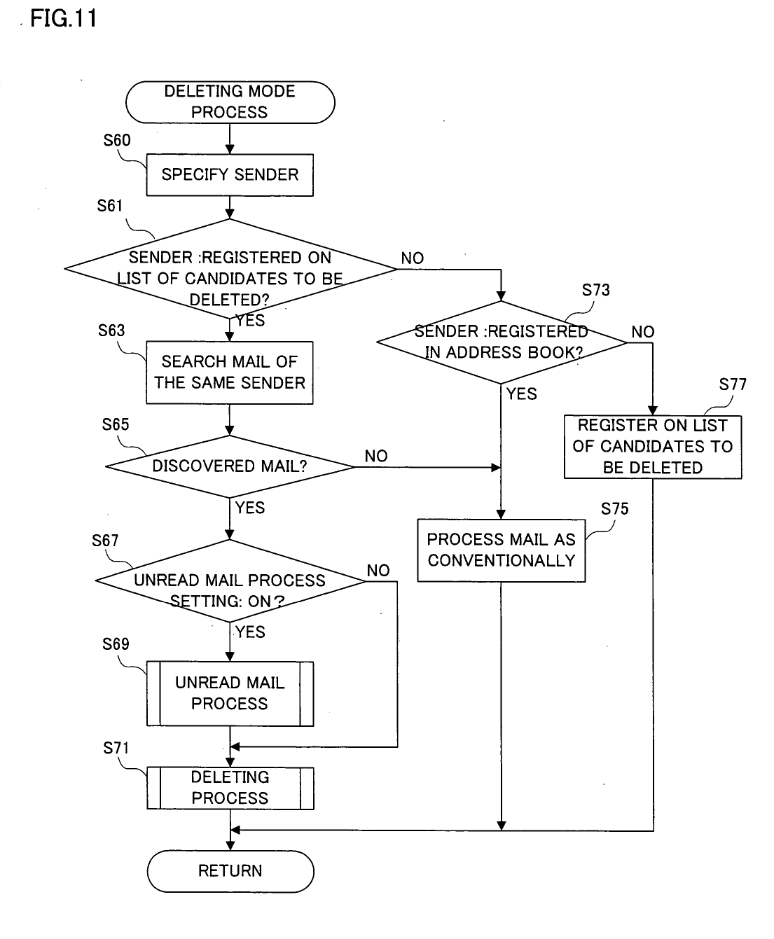

The deleting mode process in the step S57 is executed according to a flowchart in FIG. 11. First, in a step S60, the sender of the mail (mail to be noticed) received this time is specified. In a step S61, it is determined whether or not the specified sender is registered on the list of candidates to be deleted T3. Herein, if YES, the process advances to a step S63 so as to search the mail of the same sender from a plurality of the mails received in the past.

If NO in the step S61, it is determined whether or not the sender of the mail received this time is registered in the address book T2 in a step S73. Herein, if YES, a process similar to the above described step S59 is performed in a step S75. If NO, the process advances to a step S77 so as to store the sender of the received mail on the list of candidates to be deleted T3 as the candidate to be deleted.

In a step S65, it is determined whether or not the mail is discovered by a searching process of the step S63. If YES, the process advances to a step S67, and if NO, a process similar to the process in the step S49 is executed in the step S75. In a step S67, it is determined whether or not the unread mail process setting of the list of candidates to be deleted T3 is “ON”. If YES, the process advances to the step S71 via the unread mail process in a step S69. If NO in the step S77, the process directly advances to a step S71. A deleting process is executed in the step S71, and upon completion of the process, the process returns to a routine on a higher hierarchy.

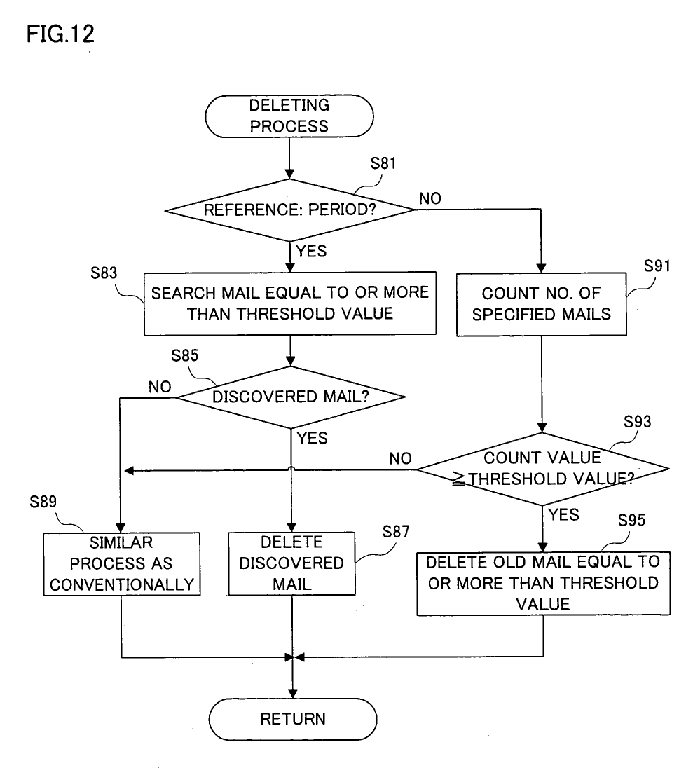

The deleting process in the step S71 is executed according to a subroutine shown in FIG. 12. First, in a step S81, it is determined whether or not the deletion determining reference is set to the “Time period”. If YES, the process advances to a step S83 so as to search a mail saved over a period that exceeds the saving period written on the list of candidates to be deleted T3 from a plurality of the mails received in the past from the sender of the mail received this time.

In the step S75, it is determined whether or not the mail is discovered by this searching process. If YES, the discovered mail is deleted in a step S87. If NO, the process advances to a step S79 so as to perform the same process as in the step S59.

If NO in the step S81, that is, if the deletion determining reference is “Number of mails”, the process advances to a step S91 so as to count the number of mails received in the past from the sender of the mail received this time. In a step S93, it is determined whether or not a count value is equal to or more than the number of mails written on the list of candidates to be deleted T3.

If NO, a process similar to the step S59 is executed in a step S89. If YES, the process advances to a step S95 so as to delete the mails other than the number of mails written on the list of candidates to be deleted T3 in chronological order according to the receiving date. Upon completion of the step S87, the step S89 or the step S95, the process returns to a routine on a higher hierarchy.

As understood from the above descriptions, the receive mail is saved into the memory 42. Upon receiving a new mail, the sender of this received mail is specified (S60), the mail received in the past from the specified sender is detected from the memory 42 (S63). Then, it is determined whether or not the specified sender is registered on the list of candidates to be deleted T3 (first register) (S61), and determined whether or not a threshold value condition regarding the saving period or a threshold value condition regarding the number of mails is satisfied between the mail received this time and the detected mail (S85, S93). If either determining result is positive, the detected mail is deleted from the memory 42 (S87, S95).

It is noted that the threshold value condition regarding the number of mails is, in other words, a condition that the number of mails existing between the oldest mail and the latest mail received from the specified sender exceeds a threshold value.

In addition, unless the specified sender is registered on the list of candidates to be deleted T3, it is determined whether or not the sender of the specified mail is registered in the address book T2 (second register) (S73). If this determining result is negative, the specified sender is registered on the list of candidates to be deleted T3 (S77).

Furthermore, if the desired address is input (S11, S77), this address is registered on the list of candidates to be deleted T3 (S13, S19). If the input address has been registered in the address book T2, the message is output (S15, S23). If there is the positive response to this message, the input address is deleted from the address book T2.

In addition, if the unread mail is included in the detected mails to be deleted, this unread mail is excluded from the candidate to be deleted.

According to this embodiment, at each time that the mail is received from a designated sender, the mail saved longer than a period that exceeds the period to be set, or the mails having any other number other than the set number of mails are automatically deleted. This eliminates a need of the operator to manually delete the unnecessary mail in the past, thus enhancing functionality. In other words, the mail within the period to be set or the mail within the number of mails to be set are not automatically deleted, and it is possible to easily confirm the mail having a short saving period or having a small number of mails. In addition, in a case of exceeding the period to be set or the number of mails to be set, unless the mail is received from the designated sender, the mail in the past is not deleted. This makes it possible for the receiver to refuse accepting the mail from the designated sender, thus allowing to continue saving the mails having its set period elapsed, or the mails that exceed the number of mails to be set.

In addition, if the sender of a mail delivery service that regularly delivers a news article, and information is registered on the list of candidates to be deleted in advance, at each time that the mail is received from the sender of this service, it is possible to automatically delete the mails of the past that exceed the period to be set or the mails having any other number other than the number of mails to be set.

It is noted that in this embodiment, the deleting mode process is made to be executed when the mail is received. However, the deleting mode process may be executed when it is completed to view the received mail.

In addition, in this embodiment, when the deleting mode is executed, the sender of the mail is made to be noticed. However, all communicating partners who belong to the same group (see FIG. 8) as the sender may be noticed.

It is noted that the list of candidates to be deleted T3 may be edited by the operation panel 36. In a case of intending to delete a designated address from the list of candidates to be deleted T3, for example, considered is an operation in which the “delete address” is selected from the sub menu screen by the operation panel 36 so as to delete the address.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A communication terminal that saves a received electronic mail into a memory, comprising:
a detector for detecting from said memory the electronic mail received in the past from a specific sender who is a sender of a noticed electronic mail;
a first determiner for determining whether or not a first condition is satisfied between said noticed electronic mail and the electronic mail detected by said detector; and
a first deletor for deleting the electronic mail detected by said detector when a determination result of said first determiner is positive.

2. A communication terminal according to claim 1, further comprising a second determiner for determining whether or not said specific sender satisfies a second condition, wherein said first determiner performs a determining operation when a determination result of said second determiner is positive.

3. A communication terminal according to claim 2, wherein said second condition includes a registering condition that an identifying code of said specific sender is registered in a first register.

4. A communication terminal according to claim 3, further comprising:
a third determiner for determining whether or not the identifying code of said specific sender is registered in a second register when said registering condition is not satisfied, and
a first registerer for registering the identifying code of said specific sender into said first register when a determination result of said third determiner is negative.

5. A communication terminal according to claim 4, further comprising:
an acceptor for accepting an input of a desired identifying code;
a second registerer for registering said desired identifying code into said first register;
an ouputter for outputting a message when said desired identifying code is registered in said second register; and
a second deletor for deleting said desired identifying code from said second register corresponding to the input in response to said message.

6. A communication terminal according to claim 1, wherein said first condition includes a first threshold value condition that a difference between a receiving date of said noticed electronic mail and a receiving data of the electronic mail detected by said detector exceeds a first threshold value.

7. A communication terminal according to claim 1, wherein said noticed electronic mail is the latest electronic mail, the electronic mail detected by said detector is the oldest electronic mail, and said first condition includes a second threshold value condition that the number of electronic mails existing between said latest electronic mail and said oldest electronic mail out of the electronic mails from said specific sender exceeds a second threshold value.

8. A communication terminal according to claim 1, further comprising an excluder for excluding an unread electronic mail from a candidate to be deleted out of the electronic mails detected by said detector.

9. A mail managing method that manages a received electronic mail, comprising the steps of:
(a) detecting from a memory the electronic mail received in the past from a specific sender who is a sender of a noticed electronic mail;
(b) determining whether or not a first condition is satisfied between said noticed electronic mail and the electronic mail detected by said step (a); and
(c) deleting the electronic mail detected by said step (a) when a determination result of said step (b) is positive.
